(19) United States
(12) Patent Application Publication
(10) Pub. No.: US 2026/0006566 A1
(43) Pub. Date: Jan. 1, 2026

(54) COMMUNICATION APPARATUS, CONTROL METHOD FOR COMMUNICATION APPARATUS, AND PROGRAM

(71) Applicant: CANON KABUSHIKI KAISHA, Tokyo (JP)

(72) Inventor: MASAKAZU TSUCHIHASHI, Kanagawa (JP)

(21) Appl. No.: 18/943,190

(22) Filed: Nov. 11, 2024

Related U.S. Application Data
(63) Continuation of application No. PCT/JP2023/015846, filed on Apr. 21, 2023.

(30) Foreign Application Priority Data
May 13, 2022 (JP) 2022-079250

(51) Int. Cl. H04W 56/00; H04W 76/14

(52) U.S. Cl. CPC H04W 56/001; H04W 76/14

(57) ABSTRACT

A communication apparatus acquires a certain time, generates a message including first information indicating the certain time and second information, which is information about a time source providing the certain time, and sends the message to one or more other communication apparatuses via a PC5 interface conforming to 3rd Generation Partnership Project (3GPP) standard.

### CROSS-REFERENCE TO RELATED APPLICATIONS

This application is a Continuation of International Patent Application No. PCT/JP2023/015846, filed Apr. 21, 2023, which claims the benefit of Japanese Patent Application No. 2022-079250, filed May 13, 2022, both of which are hereby incorporated by reference herein in their entirety.

### TECHNICAL FIELD

The present invention relates to relates to a communication apparatus, a control method for a communication apparatus and a program.

### BACKGROUND ART

In 3rd Generation Partnership Project (3GPP) (registered trademark), standard specifications concerning wireless link between communication apparatuses, which is called sidelink communication, are developed. The sidelink communication is a communication method for directly realizing wireless communication using a wireless interface called PC5 between communication apparatuses not via a mobile communication network (core network).

A communication system that uses the sidelink communication to directly perform the wireless communication between vehicles (between communication apparatuses of the respective vehicles) is disclosed in PTL 1. With the technology disclosed in the literature, sharing of information (the positions, the speeds, the vehicle control information, and so on) about peripheral vehicles enables supporting of acknowledgement, determination, and operations by a driver.

### CITATION LIST

### Patent Literature

PTL 1: Japanese Patent Laid-Open No. 2020-188405

There are various known methods to acquire an absolute time by the communication apparatus. For example, a method of receiving a Global Navigation Satellite System (GNSS) signal, a method of receiving system information (System Information Block (SIB)) reported by a base station, a method of accessing a Network Time Protocol (NTP) server on a network, and so on are exemplified. The absolute time means a practical time, such as Coordinated Universal Time (UTC), on which the world standard time is based, or a system time set for the apparatus.

In contrast, no mechanism is currently developed to acquire the absolute time in the sidelink communication. For example, when the communication apparatus is configured so as to be capable of the sidelink communication but does not support a communication function to acquire the absolute time using the above method, it is not possible to acquire the absolute time. Alternatively, also when the communication apparatus supports the communication function to acquire the absolute time but is temporarily outside the communication area, it is not possible to acquire the absolute time.

### SUMMARY OF INVENTION

In order to resolve the above problems, it is an object of the present invention to provide a mechanism for acquiring the absolute time in the sidelink communication.

As one means for achieving the above object, a communication apparatus of the present invention has the following configuration. Specifically, the communication apparatus includes an acquiring unit configured to acquire a certain time, a generating unit configured to generate a message including first information indicating the certain time and second information, which is information about a time source providing the certain time, and a sending unit configured to send the message to one or more other communication apparatuses via a PC5 interface conforming to 3rd Generation Partnership Project (3GPP) standard.

Further features of the present invention will become apparent from the following description of exemplary embodiments (with reference to the attached drawings).

### BRIEF DESCRIPTION OF DRAWINGS

FIG. 1 is a diagram illustrating an example of the configuration of a communication system.

FIG. 2A illustrates an example of the hardware configuration of a communication apparatus.

FIG. 2B illustrates an example of the functional configuration of the communication apparatus.

FIG. 3 illustrates a sequence diagram of a process for forming a synchronization group.

FIG. 4A illustrates an example of a window displayed in a display unit in the communication apparatus in the process for forming the synchronization group.

FIG. 4B illustrates an example of a window displayed in the display unit in the communication apparatus in the process for forming the synchronization group.

FIG. 4C illustrates an example of a window displayed in the display unit in the communication apparatus in the process for forming the synchronization group.

FIG. 4D illustrates an example of a window displayed in the display unit in the communication apparatus in the process for forming the synchronization group.

FIG. 4E illustrates an example of a window displayed in the display unit in the communication apparatus in the process for forming the synchronization group.

FIG. 4F illustrates an example of a window displayed in the display unit in the communication apparatus in the process for forming the synchronization group.

FIG. 4G illustrates an example of a window displayed in the display unit in the communication apparatus in the process for forming the synchronization group.

FIG. 4H illustrates an example of a window displayed in the display unit in the communication apparatus in the process for forming the synchronization group.

FIG. 4I illustrates an example of a window displayed in the display unit in the communication apparatus in the process for forming the synchronization group.

FIG. 5A illustrates an example of the format of a message used in sidelink communication according to an embodiment.

FIG. 5B illustrates an example of the format of a message used in the sidelink communication according to the embodiment.

FIG. 6A illustrates a flowchart of a sending process of a time synchronization message according to the embodiment.

FIG. 6B illustrates a flowchart of a sending process of a message other than the time synchronization message according to the embodiment.

FIG. 7 illustrates a flowchart of a receiving process of a message according to the embodiment.

### DESCRIPTION OF EMBODIMENTS

Embodiments will herein be described in detail with reference to the accompanying drawings. The embodiments described below are not intended to limit the invention according to the appended claims. Although multiple features are described in the embodiments, all the features are not essential for the invention and the multiple features may be arbitrarily combined. The same reference numerals are added to the same or similar components in the accompanying drawings and a duplicated description of such components is omitted herein.

### Configuration of Communication System

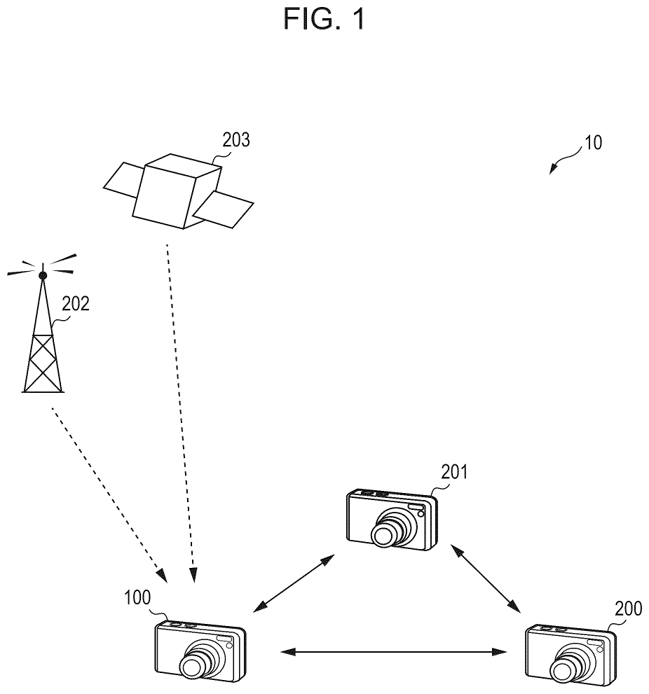

FIG. 1 is a diagram illustrating an example of the configuration of a communication system 10 according to the present embodiment. The communication system 10 is composed of communication apparatuses 100, 200, and 201, a base station 202, and a Global Navigation Satellite System (GNSS) satellite 203. In the present embodiment, the communication apparatus 100, the communication apparatus 200, and the communication apparatus 201 are configured so as to be capable of sidelink communication with each other. The sidelink communication is communication via a PC5 interface conforming to 3rd Generation Partnership Project (3GPP) standard. The communication apparatus 100 is configured so as to be capable of receiving signals from the base station 202 and the GNSS satellite 203, which are external time sources. Although the communication apparatuses 100, 200, and 201 are supposed to have a shooting function in the present embodiment, the communication apparatuses 100, 200, and 201 are not limited to this.

### Hardware Configuration of Communication Apparatus

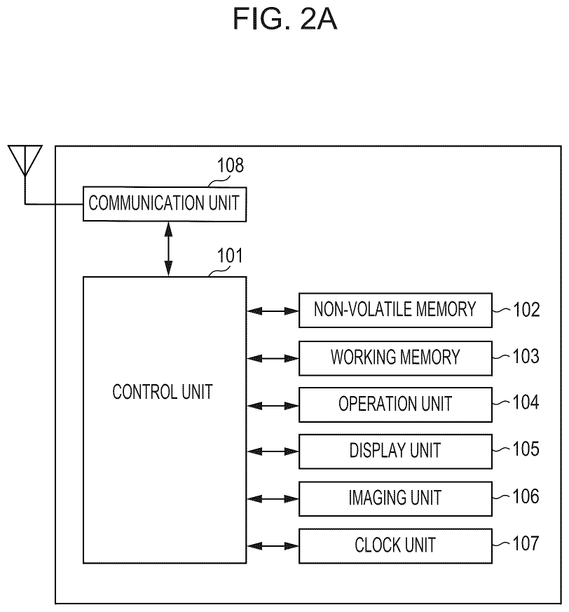

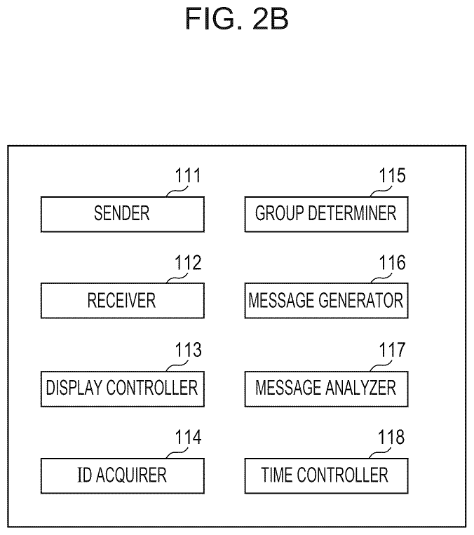

FIG. 2A illustrates an example of the hardware configuration of the communication apparatus 100. The communication apparatus 100 includes a control unit 101, a non-volatile memory 102, a working memory 103, an operation unit 104, a display unit 105, an imaging unit 106, a clock unit 107, and a communication unit 108 as an example of its hardware configuration. The communication apparatus 100 may include sensor units (not illustrated) for detecting temperature, acceleration, and so on.

The control unit 101 controls the respective components in the communication apparatus 100 in accordance with signals that are input and programs realizing one or more functions of the embodiment. Multiple pieces of hardware may share the processing, instead of the control of the entire apparatus by the control unit 101, to control the entire apparatus. The non-volatile memory 102 is an electrically erasable and recordable non-volatile memory. The programs executed by the control unit 101 and so on are stored in the non-volatile memory 102. The working memory 103 is used as a working area or the like of the control unit 101. The working memory 103 is also used for temporary storage of data and so on, which are supplied from an external apparatus via the communication unit 108.

The operation unit 104 is used for accepting an instruction for the communication apparatus 100 by a user from the user. The operation unit 104 includes operation members, such as a power button used by the user to instruct turning on and off of the power supply of the communication apparatus 100 and a dedicated connection button for staring communication with the external apparatus via the communication unit 108. The operation unit 104 may include a touch panel formed in the display unit 105. The display unit 105 displays a user interface (UI) for an interactive operation, characters, and so on.

The imaging unit 106 is a unit for capturing an image in the real space and includes, for example, an optical system such as a lens, complementary metal oxide semiconductor (CMOS), an imaging device such as a charge coupled device (CCD), an analog-to-digital (A/D) converter, a development processor, and so on. The clock unit 107 generates time information (clock) based on, for example, a certain reference clock pulse to function as a set time of the communication apparatus 100. The time information corresponds to an absolute time by the communication apparatus 100. The time information is capable of being supplied to the respective components in the communication apparatus 100 illustrated in FIG. 2A.

The communication unit 108 is an interface for connecting to the external apparatus. For example, the communication unit 108 is composed of one or more antennas for wireless communication, a modulation-demodulation circuit for processing a radio signal, and a communication controller. The communication unit 108 in the communication apparatus 100 is configured so as to perform the sidelink communication (communication between terminals) with the communication apparatuses 200 and 201, public network communication with the base station 202, and GNSS communication with the GNSS satellite 203. The public network is, for example, a Long Term Evolution (LTE) or 5th Generation (5G) cellular network conforming to 3rd Generation Partnership Project (3GPP) standard. The communication unit 108 is capable of acquiring the absolute time from the base station 202 through the public network communication. In addition, the communication unit 108 is capable of acquiring the absolute time from the GNSS satellite 203 through the GNSS communication.

Although the communication unit 108 is illustrated as one block in FIG. 2A, the communication unit 108 may be configured so as to include the individual communication units 108 and one or more antennas in order to perform the sidelink communication, the public network communication, and the GNSS communication.

The communication unit 108 may be configured so as to perform communication using a wireless local area network (LAN) conforming to Institute of Electrical and Electronics Engineers (IEEE) 802.11 series or may be configured so as to perform communication using Ethernet (registered trademark).

The hardware configurations of the communication apparatus 200 and the communication apparatus 201 may be the same as the hardware configuration illustrated in FIG. 2A. Alternatively, the communication units 108 in the communication apparatus 200 and the communication apparatus 201 may be configured so as not to have the functions for the public network communication with the base station 202 and the GNSS communication with the GNSS satellite 203.

### Functional Configuration of Communication Apparatus

FIG. 2B illustrates an example of the functional configuration of the communication apparatus 100. The communication apparatus 100 includes a sender 111, a receiver 112, a display controller 113, an identifier (ID) acquirer 114, a group determiner 115, a message generator 116, a message analyzer 117, and a time controller 118 as an example of its functional configuration. The communication apparatus 100 may further include an imaging controller (not illustrated) for controlling the imaging unit 106.

The sender 111 and the receiver 112 perform a sending process and a receiving process, respectively, via the communication unit 108 (FIG. 2A). The display controller 113 performs display control for the display unit 105 (FIG. 2A). The ID acquirer 114 acquires Layer-2 ID (hereinafter referred to as L2ID). The L2ID is information identifying each communication apparatus and a group of the communication apparatuses in the sidelink communication. For example, the ID acquirer 114 may generate the L2ID to acquire the generated L2ID or may acquire the L2ID from the outside in accordance with the 3GPP definition. The group determiner 115 determines whether the communication apparatus 100 forms a group for communication. The message generator 116 generates a message to be sent by the sender 111. The message analyzer 117 analyzes a message received by the receiver 112. The time controller 118 manages and controls the clock unit 107 (FIG. 2A). For example, the time controller 118 acquires the time information (the absolute time by the communication apparatus 100), which is indicated by the clock unit 107, and updates the time information (the set time of the communication apparatus 100) in the clock unit 107. Since the time controller 118 is capable of updating the time information in accordance with the content analyzed by the message analyzer 117, the time controller 118 may be configured so as to have the function of the message analyzer 117.

### Process Flow

In the present embodiment, in the communication system in FIG. 1, the communication apparatus 100 is capable of acquiring the absolute time from the external time sources, such as the base station 202 and the GNSS satellite 203. In contrast, the communication apparatus 200 and the communication apparatus 201 do not communicate with the external time sources and do not acquire the absolute time from the external time sources. It is supposed in the present embodiment that the communication apparatus 200 acquires the absolute time from a peripheral communication apparatus (the communication apparatus 100 or the communication apparatus 201) through the sidelink communication.

A case in which the process of acquiring the absolute time in the sidelink communication is performed by sending and receiving the absolute time in a synchronization group that is formed in advance and a case in which the process of acquiring the absolute time in the sidelink communication is performed by sending and receiving the absolute time without the formation of the synchronization group are described in the present embodiment. A process for forming the synchronization group and a process when the synchronization group is not formed, which are preprocessing of sending and receiving of the absolute time, will now be described.

### Preprocessing for Sending and Receiving of Absolute Time (Process for Forming Synchronization Group)

A case is supposed in the present embodiment, in which the communication apparatus 100 and the communication apparatus 200 form the synchronization group in the communication system 10 illustrated in FIG. 1. The communication apparatus 100 is configured so as to be capable of receiving a signal concerning the absolute time (hereinafter also simply referred to as the absolute time) from the base station 202 and the GNSS satellite 203. Accordingly, an example is described in the present embodiment, in which the communication apparatus 100 forms the synchronization group and serves as a sending-side apparatus of the absolute time and the communication apparatus 200 serves as a receiving-side apparatus of the absolute time.

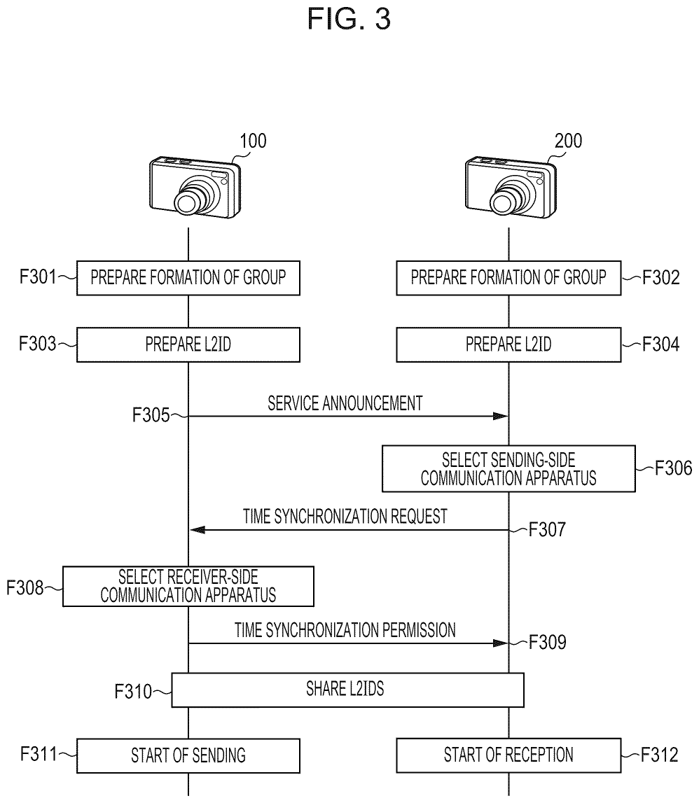

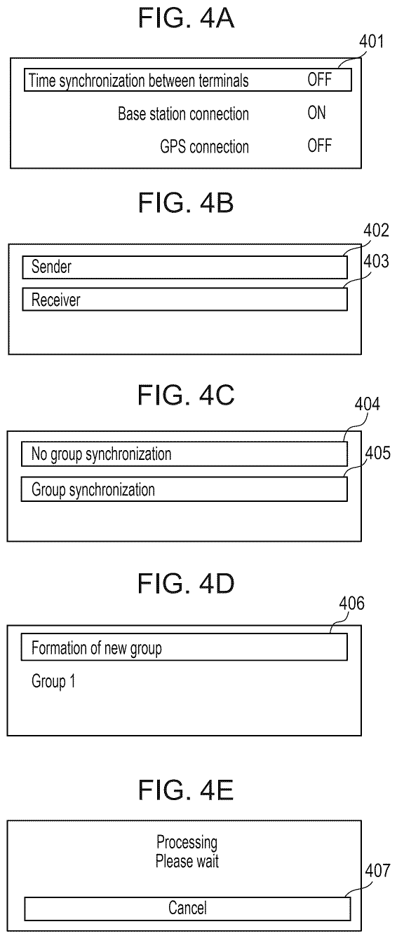

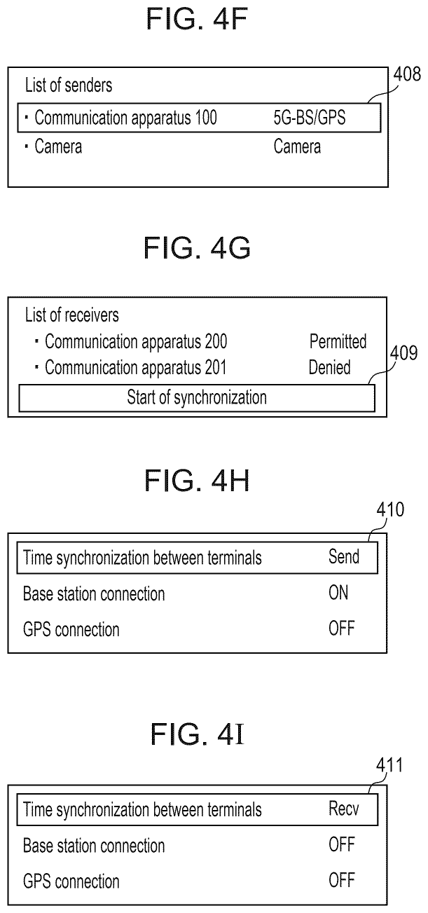

FIG. 3 illustrates a sequence diagram of a process for forming the synchronization group by the communication apparatus 100 and the communication apparatus 200. The sequence diagram in FIG. 3 is described with reference to FIG. 4A to FIG. 4I. FIG. 4A to FIG. 4I illustrate examples of windows (UIs) displayed in the display unit 105 of the communication apparatus 100 or the communication apparatus 200 in the process for forming the synchronization group. The display on the windows is performed by the display controller 113 and operations on the windows are performed by the user with the operation unit 104. In the communication apparatus 100 and the communication apparatus 200, sending and receiving of the signal are performed by the sender 111 and the receiver 112, respectively, and the acquisition of the L2ID is performed by the ID acquirer 114. “5G-BS” corresponds to the base station 202 and “GPS” corresponds to the GNSS satellite 203 in the following description.

### (1) Preparation for Synchronization Group Formation

The communication apparatus 100 and the communication apparatus 200 start the respective preparation processes for the formation of the synchronization group (F301, F302).

The user of each of the communication apparatus 100 and the communication apparatus 200 selects “Time synchronization between terminals” 401 representing connection for time synchronization between terminals from a connection menu window illustrated in FIG. 4A. The selection of the “Time synchronization between terminals” 401 makes a transition to a window for selecting the sending side and the receiving side, illustrated in FIG. 4B. In this example, the user selects “Sender” 402 representing the sending side in the communication apparatus 100 and the user selects “Receiver” 403 representing the receiving side in the communication apparatus 200. Upon selection of the “Sender” 402 or the “Receiver” 403, the window makes a transition to a window for confirming whether group synchronization is to be performed, illustrated in FIG. 4C. When the sending and receiving of the absolute time (synchronization process) is performed in the formed synchronization group, the user of each of the communication apparatus 100 and the communication apparatus 200 selects “Group synchronization” 405. Upon selection of the “Group synchronization” 405, the window makes a transition to a window illustrated in FIG. 4D for selecting formation of a new group or use of a group that is formed (group 1). It is supposed in this example that the communication apparatus 100 and the communication apparatus 200 form a new group and the user of each of the communication apparatus 100 and the communication apparatus 200 selects “Formation of new group” 406. Upon selection of the “Formation of new group” 406, the communication apparatus 100 and the communication apparatus 200 display a waiting window illustrated in FIG. 4E. A selection area for stopping or cancelling the operation, such as “Cancel” 407, may be displayed on the waiting screen.

### (2) Acquisition of L2ID

Upon completion of the preparation processes for the formation of the synchronization group in F301 and F302, the communication apparatus 100 and the communication apparatus 200 acquire (prepare) Layer-2 IDs (L2IDs) (F303, F304). The L2ID is information identifying each communication apparatus and the synchronization group of the communication apparatuses in the sidelink communication. The L2ID prepared in the communication apparatus 100, which is the sending side, is different from the L2ID prepared in the communication apparatus 200, which is the receiving side. Specifically, the communication apparatus 100 prepares the L2ID of the communication apparatus 100 itself and the L2ID for groupcasting, which is used in sending (groupcast communication) to the formed group. In contrast, the communication apparatus 200 prepares the L2ID of the communication apparatus 200 itself.

### (3) Selection of Sending Apparatus and Receiving Apparatus

Upon completion of the preparation of the L2IDs, in F305, the communication apparatus 100 starts service announcement. Information to be announced includes information indicating a time synchronization service and information (identification information) with which the communication apparatus 100 is capable of being identified. The information to be announced may include information concerning an external time source with which the communication apparatus 100 is capable of communicating. The announcement may be performed using ProSe Direct Discovery defined in 3GPP. Alternatively, when a network is formed in the wireless LAN, the announcement may be performed using Simple Service Discovery Protocol (SSDP) Discovery.

Upon reception of the service announcement, the communication apparatus 200 displays a List of senders window illustrated in FIG. 4F. The identification information (different from the L2ID) about the communication apparatus that makes the service announcement and information about the time source (the time source for the communication apparatus) from which the communication apparatus is capable of acquiring the absolute time are displayed on the List of senders window. The fact that the time sources for the communication apparatus 100 are the 5G-BS (the base station 202) and the GPS (the GNSS satellite 203 and the fact that the time source for a camera (not illustrated) is the camera itself are displayed in the example in FIG. 4F. In F306, the user of the communication apparatus 200 selects the sending-side apparatus of the absolute time (the apparatus from which the absolute time is acquired) on the List of senders window illustrated in FIG. 4F. In this example, the user of the communication apparatus 200 selects “Communication apparatus 100” 408. In F307, the communication apparatus 200 sends a time synchronization request to the selected apparatus, that is, the communication apparatus 100. The identification information (different from the L2ID) about the communication apparatus 200 is included in the time synchronization request. Upon sending of the time synchronization request, the communication apparatus 200 displays the waiting window illustrated in FIG. 4E and waits for a response to the time synchronization request from the selected apparatus (that is, the communication apparatus 100).

Upon reception of the time synchronization request from the communication apparatus 200, the communication apparatus 100 displays a List of receivers window illustrated in FIG. 4G. The communication apparatuses that have sent the time synchronization request (the apparatuses that have requested the acquisition of the absolute time) are displayed on the List of receivers window. The fact that the communication apparatuses that had sent the time synchronization request are the communication apparatus 200 and the communication apparatus 201 is displayed in the example in FIG. 4G. The user of the communication apparatus 100 determines whether the time synchronization is permitted or denied for each communication apparatus displayed on the List of receivers window. The user of the communication apparatus 100 selects “Start of synchronization” 409 at the timing when all the communication apparatuses for which the time synchronization is permitted are displayed. In the example in FIG. 4G, the “Communication apparatus 200” is determined to be the communication apparatus for which the time synchronization is permitted (F308). Upon selection of the “Start of synchronization” 409, the communication apparatus 100 displays the waiting window illustrated in FIG. 4E. In F309, the communication apparatus 100 sends a response indicating time synchronization permission to the communication apparatus 200 for which the time synchronization is permitted.

### (4) Sharing of L2ID

Upon sending of the response indicating the time synchronization permission from the communication apparatus 100 to the communication apparatus 200 in F309, in F310, the communication apparatus 100 and the communication apparatus 200 send and receive the L2IDs acquired in F303 and F304, respectively, to share the L2IDs. The communication apparatus 100 associates the L2ID of the communication apparatus 200 with the identification information about the communication apparatus 200, which are received from the communication apparatus 200, to store the L2ID of the communication apparatus 200 and the identification information about the communication apparatus 200, which are associated, in the working memory 103 as L2ID management information. The communication apparatus 100 also stores the L2ID for groupcasting in the working memory 103 as the L2ID management information. The communication apparatus 200 associates the L2ID of the communication apparatus 100 with the identification information about the communication apparatus 100, which are received from the communication apparatus 100, to store the L2ID of the communication apparatus 100 and the identification information about the communication apparatus 100, which are associated, in the working memory 103 as the L2ID management information. The communication apparatus 200 also stores the L2ID for groupcasting in the working memory 103 as the L2ID management information.

Upon completion of the sharing of the L2IDs, the communication apparatus 100 displays a menu window illustrated in FIG. 4H. The fact that the communication apparatus 100 is in a state in which the communication apparatus 100 performs a sending process of a message (hereinafter referred to as a time synchronization message) including the absolute time is indicated on the window (an area 410). In F311, the communication apparatus 100 starts sending of the time synchronization message. The sending process will be described in detail below.

Upon completion of the sharing of the L2IDs, the communication apparatus 200 displays a menu window illustrated in FIG. 4I. The fact that the communication apparatus 200 is in a state in which the communication apparatus 200 performs a receiving process of the time synchronization message is indicated on the window (an area 411). In F312, the communication apparatus 200 starts receiving of the time synchronization message. The receiving process will be described in detail below.

Preprocessing for Sending and Receiving of Absolute Time (Process when Synchronization Group is not Formed)

Next, a process when the synchronization group for sending and receiving of the absolute time is not formed will be described with reference to FIG. 4A to FIG. 4I. The communication apparatus 100 and the communication apparatus 200 are exemplified here for description.

The user of each of the communication apparatus 100 and the communication apparatus 200 selects the “Time synchronization between terminals” 401 representing connection for the time synchronization between terminals from the connection menu window illustrated in FIG. 4A. The selection of the “Time synchronization between terminals” 401 makes a transition to the window for selecting the sending side and the receiving side, illustrated in FIG. 4B. In this example, the user selects the “Sender” 402 representing the sending side in the communication apparatus 100 and the user selects the “Receiver” 403 representing the receiving side in the communication apparatus 200. Upon selection of the “Sender” 402 or the “Receiver” 403, the window makes a transition to the window for confirming whether the group synchronization is to be performed, illustrated in FIG. 4C. When the sending and the receiving of the absolute time are performed without the formation of the group, the user of each of the communication apparatus 100 and the communication apparatus 200 selects “No group synchronization” 404.

Upon selection of the “No group synchronization” 404, the communication apparatus 100 displays the menu window illustrated in FIG. 4H and the communication apparatus 200 displays the menu window illustrated in FIG. 4I. Then, the communication apparatus 100 starts sending of the time synchronization message and the communication apparatus 200 starts reception of the time synchronization message. Broadcast communication is enabled in the sidelink communication and the sending of the time synchronization message is performed using the L2ID for broadcasting (that is, in broadcast). The sending process and the receiving process will be described below.

### Messages Sent and Received in Sidelink Communication

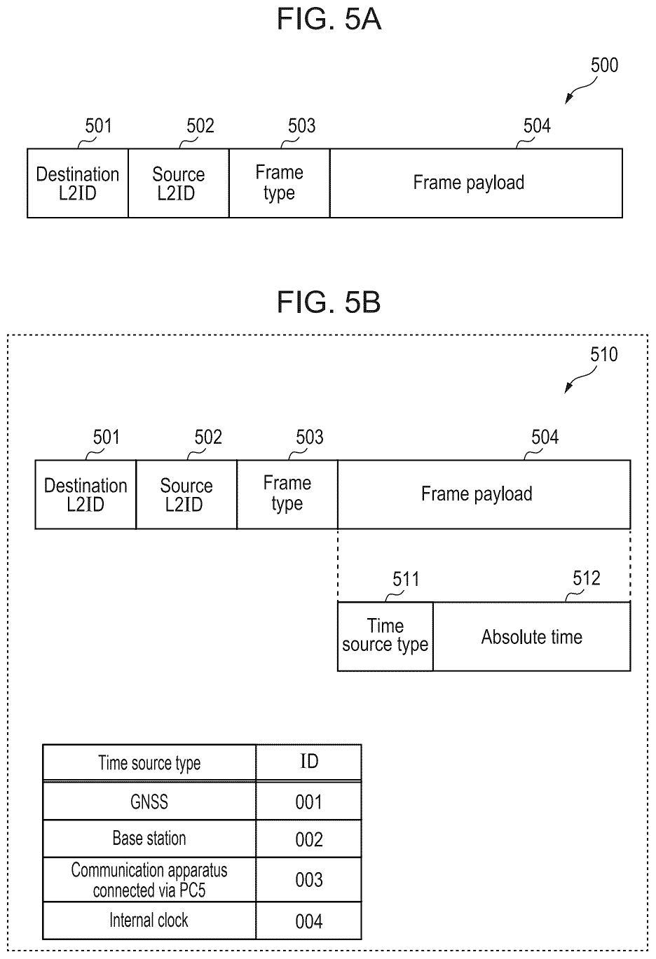

Messages that are used in the sidelink communication according to the present embodiment will now be described with reference to FIG. 5A to FIG. 5B. FIG. 5A illustrates an example of the format of a general message 500 used in the sidelink communication according to the present embodiment. Destination L2ID (Layer-2ID) 501 indicates the destination of the message 500. The L2ID is information identifying each communication apparatus in the sidelink communication, as described above. When unicast communication is performed, the communication apparatus at the sending side sets the L2ID of the communication apparatus at the receiving side in the Destination L2ID 501. When the groupcast communication is performed, the communication apparatus at the sending side sets the L2ID for groupcasting in the Destination L2ID 501. In this case, as described above in F303 and F310, it is necessary to prepare the L2ID for groupcasting in advance and to share the L2ID for groupcasting between the communication apparatuses in the group before the groupcast communication. When the broadcast communication is performed, the apparatus at the sending side sets the L2ID for broadcasting in the Destination L2ID 501. Also in this case, it is necessary to prepare the L2ID for broadcasting in advance and to share the L2ID for broadcasting between the communication apparatuses before the broadcast communication. Setting a certain ID as the L2ID for broadcasting enables the trouble of sharing the L2IDs between the communication apparatuses to be avoided. In the present embodiment, a certain (for example, fixed) ID is used as the L2ID for broadcasting.

The L2ID of the communication apparatus at the sending side is set in Source L2ID 502. The ID indicating the type of the message is set in Frame type 503. Data corresponding to the Frame type 503 is input in Frame payload 504.

FIG. 5B illustrates an example of the format of a time synchronization message 510 used in the sidelink communication according to the present embodiment. The Destination L2ID 501 and the Source L2ID 502 are the same as those in the message 500. The ID meaning the time synchronization message is set in the Frame type 503. Time source type 511 and information about Absolute time 512 are set in the Frame payload 504 as data for the time synchronization. Information concerning the time source from which the communication apparatus at the sending side acquires the absolute time is set in the Time source type 511.

An example of information set in the Time source type 511 is indicated in a lower portion of FIG. 5B. For example, when the communication apparatus at the sending side reports the absolute time acquired from the GNSS satellite, information indicating the absolute time provided by the time source is set in the Absolute time 512 when “001” is set in the Time source type 511. In the case of the communication apparatus 100, “GNSS” corresponds to the GNSS satellite 203, “Base station” corresponds to the base station 202, “Communication apparatus connected via PC5” corresponds to the communication apparatuses 200 and 201 connected in the sidelink, and “Internal clock” corresponds to the clock unit 107 in the communication apparatus 100 in FIG. 5B.

### Sending Process of Time Synchronization Message

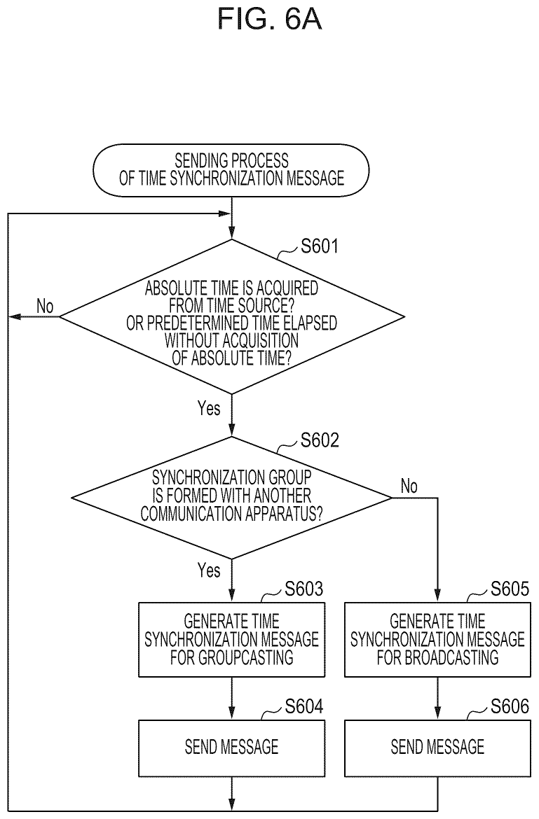

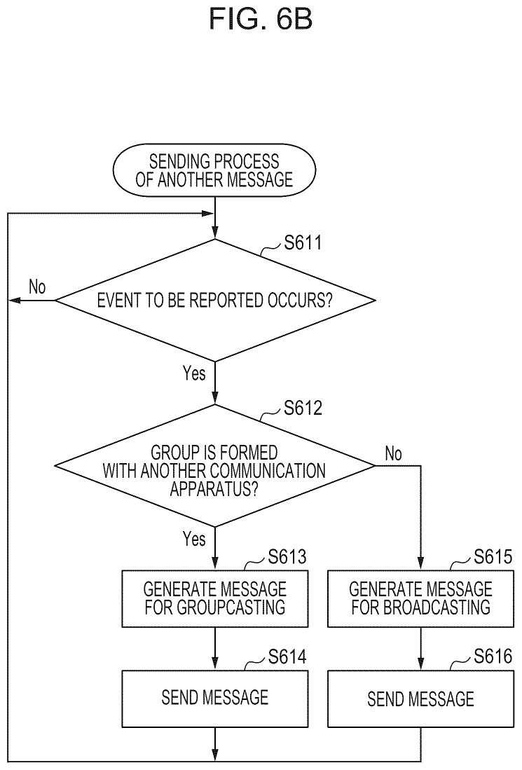

FIG. 6A illustrates a flowchart of a sending process of the time synchronization message, which is performed by the communication apparatus 100. In S601, the receiver 112 determines whether the absolute time is acquired from the external time source (the base station 202 or the GNSS satellite 203 in the present embodiment) via the communication unit 108. If the absolute time is acquired (Yes in S601), the process goes to S602. Also in a case in which the absolute time is not acquired from the external time source within a predetermined time by the receiver 112 in S601 (that is, a predetermined time elapsed in a state in which the absolute time is not acquired) (Yes in S601), the process goes to S602.

In S602, the group determiner 115 determines whether the synchronization group is formed with one or more other communication apparatuses. The determination may be performed by confirming the L2ID management information stored in the working memory 103 by the group determiner 115. If the L2ID for groupcasting for the synchronization group is stored, the group determiner 115 determines that the synchronization group is formed (Yes in S602) and the process goes to S603.

In S603, the message generator 116 generates the time synchronization message for groupcasting. The time synchronization message corresponds to the time synchronization message 510 illustrated in FIG. 5B. The message generator 116 sets the L2ID for groupcasting acquired from the L2ID management information in the Destination L2ID 501 and sets the L2ID of the communication apparatus 100 itself in the Source L2ID 502. The message generator 116 sets the ID meaning the time synchronization message in the Frame type 503. The message generator 116 sets the ID corresponding to the time source from which the absolute time is acquired in S601 in the Time source type 511 in the Frame payload 504 and sets the acquired absolute time in the Absolute time 512. If no time is acquired from the external time source, the message generator 116 sets the ID indicating “Internal clock” in the Time source type 511 and sets the set time of the communication apparatus 100 itself in the Absolute time 512. Upon completion of the generation of the message, the process goes to S604. In S604, the sender 111 sends the time synchronization message generated in S603 in groupcast. After the message is sent, the process goes back to S601, in which the communication apparatus 100 waits for receiving of the absolute time from the external time source again.

If it is determined in S602 that the synchronization group is not formed (No in S602), the process goes to S605. In S605, the message generator 116 generates the time synchronization message for broadcasting (for all the communication apparatuses). The time synchronization message corresponds to the time synchronization message 510 illustrated in FIG. 5B. The message generator 116 sets a certain ID, which is the L2ID for broadcasting, in the Destination L2ID 501. The Source L2ID 502, the Frame type 503, and the Frame payload 504 are set in the same manner as in the time synchronization message for groupcasting generated in S603. Upon completion of the generation of the message, the process goes to S606. In S606, the sender 111 sends the time synchronization message generated in S605 in broadcast. After the message is sent, the process goes back to S601, in which the communication apparatus 100 waits for receiving of the absolute time from the external time source again.

Sending Process of Message Other than Time Synchronization Message

The communication apparatus 100 is capable of concurrently performing sending of another message in parallel with the sending of the time synchronization message. The other message includes, for example, positional information about the communication apparatus 100 and sensor information about the temperature, the acceleration, and the like. The positional information is capable of being derived based on radio waves received from the GNSS satellite 203. The sensor information is capable of being acquired with the sensor units (not illustrated) in the communication apparatus 100. The format of the other message corresponds to that of the message 500 in FIG. 5A. The ID corresponding to the information to be reported is set in the Frame type 503 and the corresponding information is set in the Frame payload 504.

FIG. 6B illustrates a flowchart of a sending process of a message other than the time synchronization message, which is performed by the communication apparatus 100. In S611, the control unit 101 in the communication apparatus 100 confirms whether an event to be reported occurs. The event is, for example, receiving of the radio waves from the GNSS satellite 203 in the report of the positional information and variation of the value of a thermometer, which is the sensor unit in the communication apparatus 100, in the report of the temperature information. If an occurrence of an event is detected (Yes in S611), the process goes to S612.

In S612, the group determiner 115 determines whether the group is formed with at least one another communication apparatus. The determination may be performed by confirming the L2ID management information stored in the working memory 103 by the group determiner 115. The group may be formed for each piece of information to be reported or the synchronization group described above may be used as the group. If the group is formed (Yes in S612), the process goes to S613.

In S613, the message generator 116 generates the message for groupcasting. The message corresponds to the message 500 illustrated in FIG. 5A. The message generator 116 sets the ID corresponding to the information to be reported in the Frame type 503 and sets the corresponding information (or information about the corresponding information) in the Frame payload 504. The Destination L2ID 501 and the Source L2ID 502 are set in the same manner as in the time synchronization message for groupcasting generated in S603. Upon completion of the generation of the message, the process goes to S614. In S614, the sender 111 sends the message generated in S613 in groupcast. After the message is sent, the process goes back to S611, in which the communication apparatus 100 waits for an occurrence of an event to be reported again.

If it is determined in S612 that the group is not formed (No in S612), the process goes to S615. In S615, the message generator 116 generates the message for broadcasting (for all the communication apparatuses). The message corresponds to the message 500 illustrated in FIG. 5A. The message generator 116 sets a certain ID, which is the L2ID for broadcasting, in the Destination L2ID 501. The Source L2ID 502, the Frame type 503, and the Frame payload 504 are set in the same manner as in the message for groupcasting generated in S613. Upon completion of the generation of the message, the process goes to S616. In S616, the sender 111 sends the message generated in S615 in broadcast. After the message is sent, the process goes back to S611, in which the communication apparatus 100 waits for an occurrence of an event to be reported again.

### Receiving Process of Message

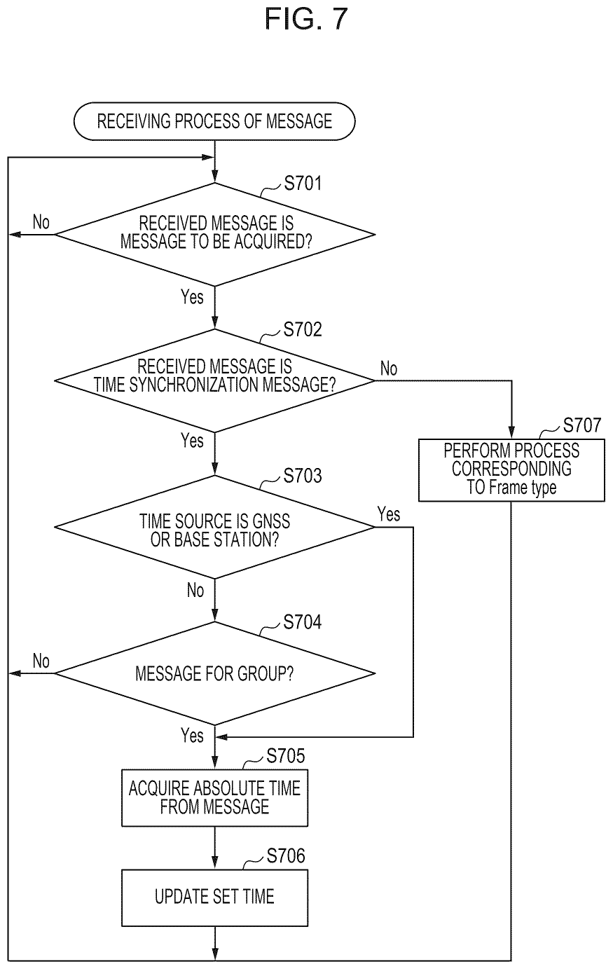

Next, a receiving process in the communication apparatus 200, which is at the receiving side of the message, will be described. FIG. 7 illustrates a flowchart of a receiving process of a message, which is performed by the communication apparatus 200. In S701, the receiver 112 receives the message through the sidelink communication. At this time, the receiver 112 confirms whether the received message is a message to be acquired. In other words, the receiver 112 confirms the L2ID management information stored in the working memory by the communication apparatus 200 to confirm whether the Destination L2ID 501 of the received message is included in the L2ID management information and is a certain ID for broadcasting. When the synchronization group is formed, the receiver 112 determines whether the Destination L2ID 501 of the received message is the L2ID for broadcasting, which is shared with the communication apparatus 100 in the formation of the group.

If it is determined that the received message is the message to be acquired (Yes in S701), the receiver 112 acquires the message. Then, the process goes to S702. If it is determined that the received message is not the message to be acquired (No in S701), the receiver 112 discards the received message and waits for reception of the next message (S701).

In S702, the message analyzer 117 determines whether the received message is the time synchronization message. The determination may be performed by confirming whether the Frame type 503 of the received message is the ID meaning the time synchronization message. If the received message is the time synchronization message (Yes in S702), the process goes to S703.

In S703, the message analyzer 117 confirms whether the Time source type 511 in the Frame payload 504 of the received message indicates the GNSS satellite 203 or the base station 202. The GNSS satellite 203 or the base station 202 is the high-precision time source. If the Time source type 511 indicates the GNSS satellite 203 or the base station 202 (Yes in S703), the process goes to S705, in which the time controller 118 acquires the Absolute time 512. If the Time source type 511 does not indicate the GNSS satellite 203 or the base station 202 (No in S703), the process goes to S704.

In S704, the message analyzer 117 determines whether the received message is the message for the group. The determination may be performed by confirming whether the Destination L2ID 501 of the received message is the L2ID for groupcasting. If the received message is not the message for the group (No in S704), the time controller 118 does not acquire the Absolute time 512 and the process goes back to S701, in which the communication apparatus 200 waits for reception of a message again. If the received message is the message for the group (Yes in S704), the time controller 118 acquires the Absolute time 512 (S705). As described above, the communication apparatus 200 is configured so as to acquire the absolute time reported to the synchronization group even if the communication apparatus 200 determines that the time source is not the high-precision time source (that is, is not the GNSS satellite 203 or the base station 202).

Upon acquisition of the Absolute time 512 by the time controller 118 in S705, in S706, the time controller 118 updates the set time with the acquired absolute time. Upon completion of the update of the time, the process goes back to S701, in which the communication apparatus 200 waits for reception of a message again.

If it is determined in S702 that the received message is not the time synchronization message (No in S702), the process goes to S707, in which the communication apparatus 200 performs the process corresponding to the Frame type 503. For example, when the Frame type 503 indicates inclusion of the positional information, the communication apparatus 200 is capable of acquiring the positional information from the Frame payload 504 to use the acquired positional information as the positional information about the communication apparatus 200 itself. Alternatively, when the Frame type 503 indicates inclusion of the temperature information, the communication apparatus 200 is capable of associating the temperature information with the source communication apparatus 100 to use the temperature information for detection of any abnormality of the communication apparatus in the group. Upon completion of the process corresponding to the Frame type, the process goes back to S701, in which the communication apparatus 200 waits for reception of a message again.

Since the sending process by the communication apparatus 100, which is described above with reference to FIG. 6A and FIG. 6B, is applicable to the sending process by the communication apparatus 201, a description of the sending process by the communication apparatus 201 is omitted herein.

### Examples of Operations in Communication System 10

Examples of the operations of the respective communication apparatuses will now be described with reference to the communication system illustrated in FIG. 1.

First, an operation to send and receive the absolute time in the synchronization group that is formed in advance will be described.

The communication apparatus 100 and the communication apparatus 200 form the group. The communication apparatus 100 is set as the sending side and the communication apparatus 200 is set as the receiving side. Here, the communication apparatus 201 is an apparatus that does not belong to the group.

The communication apparatus 100 acquires the absolute time from the base station 202 or the GNSS satellite 203, which is the external time source. The communication apparatus 200 includes the information indicating the absolute time and the information about the time source in the time synchronization message and sends the message in groupcast using the L2ID for groupcasting for the time synchronization.

Since the communication apparatus 201 does not communicate with the base station 202 or the GNSS satellite 203, the communication apparatus 201 acquires the absolute time of the communication apparatus 201 itself. The communication apparatus 201 includes the information indicating the absolute time and the information about the time source (the communication apparatus 201) in the time synchronization message and sends the message in broadcast using the L2ID for broadcasting.

The communication apparatus 200 receives the time synchronization message from the communication apparatus 100, confirms that the time source is the base station 202 or the GNSS satellite 203 (that is, the high-precision time source), and acquires the absolute time from the message.

In contrast, the communication apparatus 200 receives the time synchronization message from the communication apparatus 201, confirms that the time source is the communication apparatus 201 (that is, the no-high-precision time source), and does not acquire the absolute time from the message.

Through the above operation, the communication apparatus 100 and the communication apparatus 200, which form the synchronization group, are capable of synchronizing with each other at the time of the communication apparatus 100.

As described above, the formation of the synchronization group enables the communication apparatus to which the time is reported to be limited to exclude the influence of the time information reported by the third-party communication apparatus. In addition, the communication apparatuses in the synchronization group are capable of using the same absolute time in the group by acquiring the absolute time using the time synchronization message from another communication apparatus in the group. In addition, the communication apparatuses at the receiving side are capable of receiving the same time synchronization message by classifying the respective communication apparatuses into the sending side and the receiving side in the formation of the group and limiting the number of the communication apparatuses at the sending side to one.

Next, an operation to send and receive the absolute time without the formation of the synchronization group will be described.

The communication apparatus 100 and the communication apparatus 201 are set as the sending side and the communication apparatus 200 is set as the receiving side.

The communication apparatus 100 acquires the absolute time from the base station 202 or the GNSS satellite 203, which is the external time source. The communication apparatus 200 includes the information indicating the absolute time and the information about the time source in the time synchronization message and sends the message in broadcast using the L2ID for broadcasting.

Since the communication apparatus 201 does not communicate with the base station 202 or the GNSS satellite 203, the communication apparatus 201 acquires the absolute time of the communication apparatus 201 itself. The communication apparatus 201 includes the information indicating the absolute time and the information about the time source (the communication apparatus 201) in the time synchronization message and sends the message in broadcast using the L2ID for broadcasting.

The communication apparatus 200 receives the time synchronization message from the communication apparatus 100, confirms that the time source is the base station 202 or the GNSS satellite 203 (that is, the high-precision time source), and acquires the absolute time from the message.

In contrast, the communication apparatus 200 receives the time synchronization message from the communication apparatus 201, confirms that the time source is the communication apparatus 201 (that is, the no-high-precision time source), and does not acquire the absolute time from the message.

Through the above operation, the communication apparatus 200 is capable of acquiring the high-precision absolute time without the formation of the synchronization group.

The advantage of sending and receiving the absolute time without the formation of the synchronization group is the fact that the time synchronization is capable of being performed without the group formation process. In addition, when another communication apparatus reporting the absolute time exists around the communication apparatus, the communication apparatus is capable of acquiring the absolute time without performing the control to prepare the communication apparatus at the sending side.

As described above, according to the above embodiment, reporting the message including the information about the absolute time and the time source by the communication apparatus at the sending side enables the communication apparatus at the receiving side to acquire the absolute time with desired precision in the communication apparatuses capable of the sidelink communication. In addition, in the formation of the synchronization group, it is possible to synchronize the absolute time between the communication apparatuses performing the sidelink communication.

Although the example is described in the above embodiment in which the absolute time is sent and received between the multiple communication apparatuses performing the sidelink communication via the PC5 interface, the communication between the multiple communication apparatuses is not limited to the sidelink communication. For example, the present embodiment is applicable to a case in which communication using an interface other the PC5 interface is performed and a case using an arbitrary communication method capable of direct communication between the communication apparatuses.

Although the base station (the base station 202) in the public network and the GNSS satellite (the GNSS satellite 203) are used as the external time sources (the high-precision time sources) in the present embodiment, an NTP server on a network or an arbitrary time providing system capable of providing the absolute time or reference time may be used.

### OTHER EMBODIMENTS

The present invention is capable of being realized by a process in which programs realizing one or more functions of the above embodiments is supplied to a system or an apparatus via a network or a storage medium and one or more processors in the computer of the system or the apparatus read out and execute the programs. In addition, the present invention is capable of being realized by a circuit (for example, an application specific integrated circuit (ASIC)) realizing one or more functions.

The invention is not restricted by the above embodiments and various change and modifications are available without departing from the spirit and the scope of the invention. Accordingly, the claims are appended in order to publicize the scope of the invention.

According to the present invention, a mechanism for acquiring the absolute time in the sidelink communication is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
an acquiring unit configured to acquire a certain time;
a generating unit configured to generate a message including first information indicating the certain time and second information, which is information about a time source providing the certain time; and
a sending unit configured to send the message to one or more other communication apparatuses via a PC5 interface conforming to 3rd Generation Partnership Project (3GPP) standard.

2. The communication apparatus according to claim 1,
wherein the sending unit sends the message in broadcast to the one or more other communication apparatuses.

3. The communication apparatus according to claim 1, further comprising:
a forming unit configured to form a group including the communication apparatus and at least one of the one or more other communication apparatuses,
wherein the sending unit sends the message in groupcast to the group.

4. The communication apparatus according to claim 1,
wherein, in a case where the certain time is acquired from an external time source within a predetermined time by the acquiring unit, the generating unit includes information indicating the certain time provided by the external time source and information concerning the external time source in the message as the first information and the second information, respectively.

5. The communication apparatus according to claim 4,
wherein, in a case where the certain time is not acquired from the external time source within the predetermined time, the acquiring unit acquires the certain time provided by the communication apparatus, and
wherein the generating unit includes information indicating the certain time provided by the communication apparatus and information identifying the communication apparatus in the message as the first information and the second information, respectively.

6. The communication apparatus according to claim 1,
wherein the external time source is another apparatus and the other apparatus is a base station capable of communicating with the communication apparatus or a Global Navigation Satellite System (GNSS) satellite.

7. A communication apparatus comprising:
a receiving unit configured to receive a message including first information indicating a certain time and second information, which is information about a time source providing the certain time, from another communication apparatus via a PC5 interface conforming to 3rd Generation Partnership Project (3GPP); and
an updating unit configured to update a set time of the communication apparatus based on the first information and the second information included in the message.

8. The communication apparatus according to claim 7,
wherein the updating unit includes a first determining unit configured to determine whether the time source indicated by the second information included in the message is a certain apparatus, and
wherein, in a case where the first determining unit determines that the time source is the certain apparatus, the updating unit updates the set time of the communication apparatus using the first information.

9. The communication apparatus according to claim 8,
wherein the updating unit further includes a second determining unit configured to determine whether the message is a message for a group that is formed by the other communication apparatus and that includes the other communication apparatus and the communication apparatus, and
wherein, in a case where the first determining unit determines that the time source is not the certain apparatus and the second determining unit determines that the message is a message for the group, the updating unit updates the set time of the communication apparatus.

10. The communication apparatus according to claim 8,
wherein the certain apparatus is a base station capable of communicating with the communication apparatus or a Global Navigation Satellite System (GNSS) satellite.

11. A control method for a communication apparatus, the control method comprising:
acquiring a certain time;
generating a message including first information indicating the certain time and second information, which is information about a time source providing the certain time; and
sending the message to one or more other communication apparatuses via a PC5 interface conforming to 3rd Generation Partnership Project (3GPP) standard.

12. A control method for a communication apparatus, the control method comprising:
receiving a message including first information indicating a certain time and second information, which is information about a time source providing the certain time, from another communication apparatus via a PC5 interface conforming to 3rd Generation Partnership Project (3GPP); and
updating a set time of the communication apparatus based on the first information and the second information included in the message.

13. A non-transitory computer readable storage medium that stores a program for causing a communication apparatus to perform operations comprising:
acquiring a certain time;
generating a message including first information indicating the certain time and second information, which is information about a time source providing the certain time; and
sending the message to one or more other communication apparatuses via a PC5 interface conforming to 3rd Generation Partnership Project (3GPP) standard.
